(19) United States
(12) Patent Application Publication
(10) Pub. No.: US 2021/0291000 A1
(43) Pub. Date: Sep. 23, 2021

(54) FIRE SUPPRESSION SYSTEMS AND METHODS OF CONTROLLING FLOW OF FIRE SUPPRESSANT AGENTS IN FIRE SUPPRESSION SYSTEMS

(71) Applicant: Kidde Technologies, Inc., Wilson, NC (US)

(72) Inventor: Mark P. Fazzio, Wilson, NC (US)

(21) Appl. No.: 17/203,858

(22) Filed: Mar. 17, 2021

Related U.S. Application Data
(60) Provisional application No. 62/992,268, filed on Mar. 20, 2020.

(51) Int. Cl. A62C 35/68; A62C 35/64; F15D 1/02

(52) U.S. Cl. CPC A62C 35/68; F15D 1/025; A62C 35/64

(57) ABSTRACT

A low rate discharge section of a fire suppression system includes a low rate discharge conduit with a source segment and a supply segment, a housing connecting the source segment to the supply segment, and an orifice plate. The orifice plate is arranged within the housing, fluidly couples the source segment to the supply segment, and defines two or more orifices therethrough to choke flow of a fire suppressant traversing the orifice plate. Fire suppression and systems and methods of controlling flow of fire suppressant agents through fire suppression systems are also described.

### CROSS-REFERENCE TO RELATED APPLICATIONS

This application claims priority to U.S. Provisional Application No. 62/992,268 filed Mar. 20, 2020, the contents of which are incorporated herein by reference in their entirety.

### BACKGROUND

The present disclosure is generally directed to fluid systems, and more particularly to controlling fluid flow in fluid systems, such as fire suppression systems for cargo compartments on aircraft.

Vehicles, such as aircraft, commonly include fire suppression systems to protect spaces within the vehicle from fire. Such fire protection systems are generally arranged to introduce a fire suppressant agent into a protected space from a suppressant reservoir upon detection of a fire within the protected space, generally using a high rate discharge (HRD) mode and a low rate discharge (LRD) mode. Upon actuation the fire suppression system initially responds in the HRD mode, the fire suppression system issuing fire suppressant agent into the protected space at a relatively high mass flow rate and for a relatively short period of time to knock down the fire. The fire suppression system thereafter operates in the LRD mode, the fire suppression system issuing fire suppressant agent into the protected space at a lower mass flow rate to prevent the fire from restarting for longer period of time.

Controlling issue of fire suppressant agent in the HRD mode and the LRD mode generally requires using flow control devices. For example, pressure regulators are commonly employed to control pressure of fire suppressant issued into the protected space. Flow control valves are commonly used to control the mass flow rate of fire suppressant issues into the protected space, typically in cooperation with a controller and/or software. Such flow control devices add weight and complexity to the fire suppression system.

Such systems and methods have generally been acceptable for their intended purposes. However, there remains a need in the art for improved LRD sections for fire suppression systems, fire suppression systems, and methods of controlling flow of fire suppressant agents through fire suppression systems.

### BRIEF DESCRIPTION

Disclosed is a low rate discharge (LRD) section of a fire protection system. The LRD section includes: an LRD conduit with a source segment and a supply segment; a housing connecting the source segment to the supply segment; and an orifice plate arranged within the housing and fluidly coupling the source segment to the supply segment, wherein the orifice plate defines a plurality of orifices therethrough to choke flow of a fire suppressant traversing the orifice plate.

In addition to one or more of the features described above, or as an alternative to any of the foregoing embodiments, the housing has an inlet port with an inlet port flow area, wherein each of plurality of orifices has an orifice flow area, and wherein the orifice flow area is smaller than the inlet port flow area.

In addition to one or more of the features described above, or as an alternative to any of the foregoing embodiments, an aggregate of the orifice flow areas is smaller than the inlet port flow area.

In addition to one or more of the features described above, or as an alternative to any of the foregoing embodiments, an aggregate of the orifice flow areas is larger than the inlet port flow area.

In addition to one or more of the features described above, or as an alternative to any of the foregoing embodiments, an aggregate of the orifice flow areas is equivalent to the inlet port flow area.

In addition to one or more of the features described above, or as an alternative to any of the foregoing embodiments, the housing has an outlet port with an outlet port flow area, wherein each of plurality of orifices has an orifice flow area, and wherein the orifice flow area is smaller than the outlet port flow area.

In addition to one or more of the features described above, or as an alternative to any of the foregoing embodiments, an aggregate of the orifice flow area is (a) smaller than the outlet port flow area, (b) larger than the outlet port flow area, or (c) equivalent to the outlet port flow area.

In addition to one or more of the features described above, or as an alternative to any of the foregoing embodiments, a first orifice defines a first flow axis, wherein a second orifice defines a second flow axis, wherein the second flow axis is parallel to the first flow axis.

In addition to one or more of the features described above, or as an alternative to any of the foregoing embodiments, the LRD can further include an LRD pressure vessel fluidly coupled to the orifice plate by the source segment.

In addition to one or more of the features described above, or as an alternative to any of the foregoing embodiments, the LRD can further include a fire suppressant agent contained within the LRD pressure vessel.

In addition to one or more of the features described above, or as an alternative to any of the foregoing embodiments, the LRD can further include one or more of a chlorofluorocarbon, a hydrochlorofluorocarbon, and a hydrofluorocarbon compound contained within the LRD pressure vessel.

In addition to one or more of the features described above, or as an alternative to any of the foregoing embodiments, the LRD can further include an LRD element arranged along the source segment with an LRD active state and an LRD inactive state, the LRD element fluidly coupling an LRD pressure vessel to the orifice plate in the LRD active state, the LRD element fluidly separating the LRD pressure vessel to the orifice plate in the LRD inactive state.

In addition to one or more of the features described above, or as an alternative to any of the foregoing embodiments, the LRD section does not include a pressure regulating device; and wherein the LRD section does not include a flow control device.

In addition to one or more of the features described above, or as an alternative to any of the foregoing embodiments, the plurality of orifices are configured to choking flow of a fire suppressant agent traversing the orifice plate, and wherein the plurality of orifices are configured to provide a continuous, choked, fire suppressant flow having a mass flow rate sufficient to maintain a predetermined concentration level within a protected space during decay of pressure within an LRD pressure vessel connected to the source segment.

Also disclosed is fire suppression system that includes a protected space; an LRD section as in any prior embodiment, wherein the supply segment fluidly couples the orifice plate to the protected space; and a high rate discharge (HRD) section fluidly coupled to the protected space by an HRD conduit.

In addition to one or more of the features described above, or as an alternative to any of the foregoing embodiments, the system further includes an LRD pressure vessel connected to the protected space by the source segment of the LRD section; one or more of a chlorofluorocarbon, a hydrochlorofluorocarbon, and a hydrofluorocarbon compound contained within the LRD pressure vessel; an HRD pressure vessel connected to the protected space by the HRD conduit; and one or more of a chlorofluorocarbon, a hydrochlorofluorocarbon, and a hydrofluorocarbon compound contained within the HRD pressure vessel.

In addition to one or more of the features described above, or as an alternative to any of the foregoing embodiments, the system further includes: an LRD element arranged along the LRD source segment and separating an LRD pressure vessel from the protected space; and an HRD element arranged along the HRD conduit and separating an HRD pressure vessel from the protected space.

In addition to one or more of the features described above, or as an alternative to any of the foregoing embodiments, the system further includes: a sensor operatively connected to the LRD element and the HRD element, the sensor disposed in communication with the protected space, wherein the protected space is a cargo compartment on an aircraft.

Also disclosed is a method of controlling flow of a fire suppressant agent through a fire suppression system. The method includes: at a low rate discharge (LRD) section including an LRD conduit having source segment and a supply segment, a housing connecting the source segment to the supply segment, and an orifice plate arranged within the housing and fluidly coupling the source segment to the supply segment, the orifice plate defining therethrough a plurality of orifices; receiving a fire suppressant flow at the housing through the source segment; choking flow of a fire suppressant traversing the orifice plate; and issuing a continuous, choked, fire suppressant flow to a protected space through the supply segment.

In any prior method, the fire suppressant flow can have a mass flow rate sufficient to maintain a predetermined concentration level within the protected space during decay of pressure within an LRD pressure vessel connected to the source segment.

Technical effects of the present disclosure include fire suppression systems with the capability to continuously discharge fire suppressant from fixed volume suppressant reservoirs in fire protection systems at constant flow rates and constant mass flow rate over time. Technical effects of the present disclosure also include fire suppression systems with the capability to continuously discharge fire suppressant from fixed volume suppressant reservoirs at constant flow rates and constant mass flow rate without pressure regulators and/or flow control valves.

### BRIEF DESCRIPTION OF THE DRAWINGS

The following descriptions should not be considered limiting in any way. With reference to the accompanying drawings, like elements are numbered alike:

FIG. 1 is a schematic view of a fire suppression system constructed in accordance with the present disclosure, showing the fire suppression system with a low rate discharge (LRD) section and a high rate discharge (HRD) section connected to a cargo compartment on an aircraft;

FIG. 2 is a schematic view of the fire suppression system of FIG. 1, showing the LRD section and the HRD section;

FIG. 3 is a schematic view of the LRD section of the fire suppression system of FIG. 1, showing an orifice plate seated within the interior of a housing for choking flow of a fire suppressant agent to the cargo compartment;

FIG. 4 is a plan view of the orifice plate of the LRD section of FIG. 1, showing a multitude of flow apertures arranged to provide choked flows of with an aggregate flow rate for continuous low rate discharge of fire suppressant agent into the cargo compartment;

FIG. 5 is a graph showing flow mass flow rate through the orifice plate of the LRD section of FIG. 1, showing a continuous mass flow rate during pressure decay to a predetermined pressure level; and

FIG. 6 is a block diagram of a method of controlling flow of a fire suppressant agent through a fire suppression system, showing operations of the method according to an example.

### DETAILED DESCRIPTION

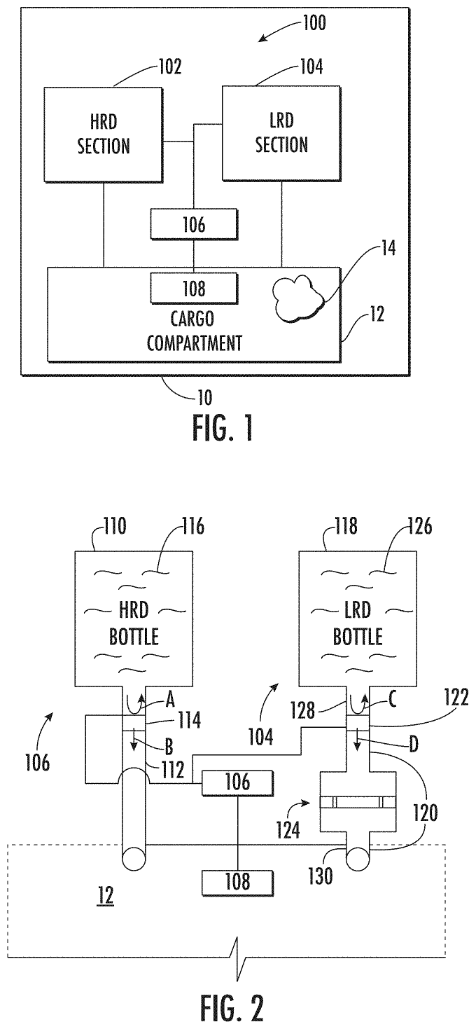

Reference will now be made to the drawings wherein like reference numerals identify similar structural features or aspects of the subject disclosure. For purposes of explanation and illustration, and not limitation, a partial view of an example of a fire suppression system having a low rate discharge section is shown in FIG. 1 and is designated generally by reference character 100. Other examples of low rate discharge sections for fire suppression systems, fire suppression systems, and methods of controlling flow of fire suppressant agents through fire suppression systems are provided in FIGS. 2-6, as will be described. The systems and methods described herein can be used to provide fire suppression for protected spaces on vehicles, such as for cargo compartments on aircraft, though the present disclosure is not limited to any particular type of protected space or to aircraft in general.

Referring to FIG. 1, a vehicle 10, e.g., an aircraft, is shown. The vehicle 10 includes the fire suppression system 100 and a protected space 12 and the fire suppression system 100. The fire suppression system 100 includes a high rate discharge (HRD) section 102, a low rate discharge (LRD) section 104, an actuator 106, and a sensor 108. Although shown and described herein in the context of a cargo compartment on an aircraft it is to be understood and appreciated that other types of fire suppression systems can also benefit from the present disclosure, such as fire suppression systems employed in marine and terrestrial applications.

The sensor 108 is arranged for detecting presence of fire 14 within the protected space 12 and is disposed in communication with the actuator 106. The actuator 106 is operably connected to the HRD section 102 and the LRD section 104, and is arranged to actuate the HRD section 102 and the LRD section 104 upon receipt of a fire detected signal 16 from the sensor 108.

With reference to FIG. 2, the HRD section 102 and the LRD section 104 are shown. The HRD section 102 includes an HRD pressure vessel 110, an HRD conduit 112, and an HRD element 114. The HRD pressure vessel 110, e.g., a bottle, contains therein an HRD fire suppressant agent 116 and is fluidly coupled to the protected space 12 by the HRD conduit 112. In certain examples the HRD fire suppressant agent 116 includes a compressed gas. Examples of suitable HRD fire suppressant agents contained within the HRD pressure vessel 110 include chlorofluorocarbon, hydrochlorofluorocarbon, and hydrofluorocarbon compounds.

The HRD conduit 112 connects the HRD pressure vessel 110 to the protected space 12 and provides fluid communication between the HRD pressure vessel 110 and the protected space 12. The HRD element 114 is arranged along the HRD conduit 112 and has an HRD inactive state A, wherein the HRD element 114 fluidly separates (e.g., hermetically) the HRD pressure vessel 110 from the protected space 12, and an HRD active state B, wherein the HRD element 114 fluidly connects the HRD pressure vessel 110 to the protected space 12 for issue of the HRD fire suppressant agent 116 into the protected space 12. It is contemplated that HRD element 114 be operably associated with the actuator 106 for switching from the HRD inactive state A to HRD active state B upon detection of the fire 14 (shown in FIG. 1) in the protected space 12.

The LRD section 104 includes an LRD pressure vessel 118, an LRD conduit 120, an LRD element 122, and an LRD plenum 124. The LRD pressure vessel 118, e.g., a bottle, contains therein an LRD fire suppressant agent 126. In certain examples the LRD fire suppressant agent 126 includes a compressed gas. Examples of suitable LRD fire suppressant agents contained within the LRD pressure vessel 118 include chlorofluorocarbon, hydrochlorofluorocarbon, and hydrofluorocarbon compounds. In certain examples the HRD fire suppressant agent 116 and the LRD fire suppressant agent 126 include a common fire suppressant agent.

The LRD conduit 120 includes an LRD source segment 128 and an LRD supply segment 130. The LRD source segment 128 fluidly couples the LRD pressure vessel 118 to the LRD plenum 124. The LRD supply segment 130 fluidly couples the LRD plenum 124 to the protected space 12. The LRD element 122 is arranged along the LRD source segment 128 and has an LRD inactive state C, wherein the LRD element 122 fluidly separates (e.g., hermetically) the LRD pressure vessel 118 from the LRD plenum 124, and an LRD active state D, wherein the LRD element 122 fluidly connects the LRD pressure vessel 118 to the LRD plenum 124 for issue of the LRD fire suppressant agent 126 therethrough and into the protected space 12. It is contemplated that LRD element 122 be operably associated with the actuator 106 for switching from the LRD inactive state C to the LRD active state D upon detection of the fire 14 (shown in FIG. 1) in the protected space 12.

In certain examples the LRD section 104 does not include a pressure regulating device, simplifying the arrangement of the fire suppression system 100. In accordance with certain examples the LRD section does not include a flow control device, also simplifying the arrangement of the fire suppression system 100. It is also contemplated that, in accordance with certain examples, that the LRD section 104 include neither a pressure regulating device nor a flow control device.

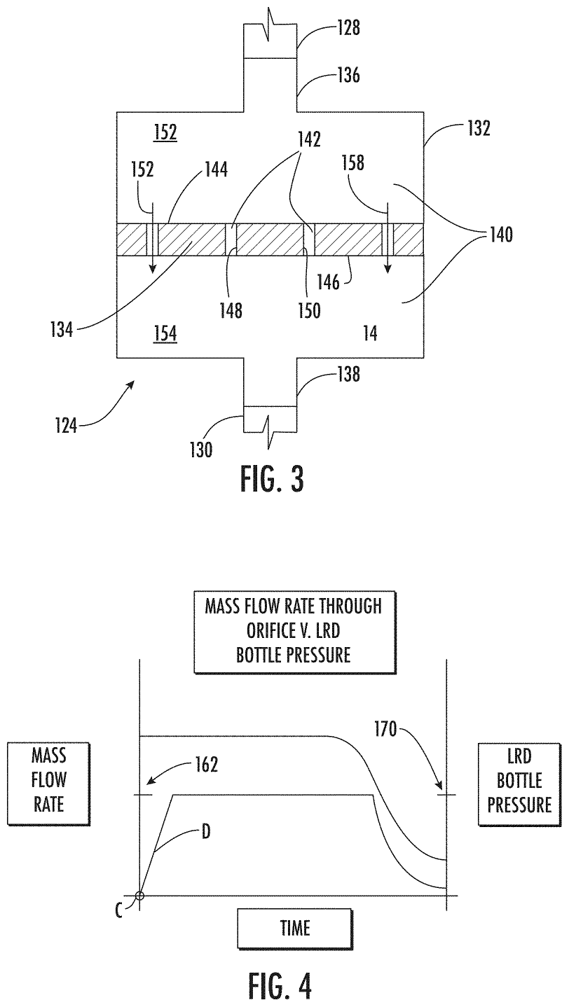

With reference to FIG. 3, the LRD plenum 124 is shown. The LRD plenum 124 includes a housing 132 and an orifice plate 134. The housing 132 has an inlet port 136, an outlet port 138, and an interior 140. The inlet port 136 is connected to the LRD pressure vessel 118 by the LRD source segment 128 of the LRD conduit 120, the outlet port 138 is connected to the protected space 12 by the LRD supply segment 130, and the inlet port 136 and outlet port 138 are both in fluid communication with the interior 140 of the housing 132.

The orifice plate 134 is seated within the interior 140 of the housing 132 and defines a plurality of orifices 142 therethrough. More specifically, the orifice plate 134 has a source surface 144, a supply surface 146, a first orifice 148, and at least one second orifice 150. The source surface 144 fluidly opposes the inlet port 136 and defines therebetween a high-pressure plenum portion 152 within the housing 132. The supply surface 146 fluidly opposes the outlet port 138 and defines therebetween a low-pressure plenum portion 154 within the housing 132. The first orifice 148 and the at least one second orifice 150 each extend between the source surface 144 and the supply surface 146, the first orifice 148 and the at least one second orifice 150 fluidly coupling the high-pressure plenum portion 152 and the low-pressure plenum portion 154. It is contemplated that each of the plurality of orifices 142 define a plurality of flow axes 156, e.g., a first flow axis 158 and a second flow axis 160, and that each of the plurality of flow axes 156 are parallel with one another.

With reference to FIG. 4, it is contemplated that each of plurality of orifices 142 (shown in FIG. 3) be configured to choke flow between the high-pressure plenum portion 152 (shown in FIG. 3) and the low-pressure plenum portion 154 (shown in FIG. 3). In this respect, for pressures above a predetermined pressure 170, each of the plurality of orifices 142 provide a substantially constant mass flow 162 through the respective aperture.

As will be appreciated by those of skill in the art, choked flow is compressible flow effect whereby fluid velocity becomes “choked” or limited. When flowing a fluid at a given pressure and temperature through a constriction in a lower pressure environment, e.g., from the high-pressure plenum portion 152 (shown in FIG. 3) to the low-pressure plenum portion 154 (shown in FIG. 3) through each of the plurality of orifices 142 (shown in FIG. 3), the fluid velocity increases. At initially subsonic upstream conditions the conservation of mass principle requires that the fluid velocity increase as it flows through the smaller flow area of the plurality of orifices 142 of the orifice plate 134. At the same time, the venturi effect causes the static pressure and the density to decrease at the constriction. Choked flow develops where the mass flow reaches a level where it will not increase with further decrease in the downstream pressure environment for pressures above the predetermined pressure.

As will also be appreciated by those of skill in the art in view of the present disclosure, choking flow through the first orifice 148 and the second orifice 150 limits flow through the orifice plate 134 between the LRD pressure vessel 118 and the protected space 12. Since the limited mass flow associated with the choked flow condition provided by the first orifice 148 and the second orifice 150 may be insufficient to provide an LRD flow sufficient to prevent reignition of the fire 14 (shown in FIG. 1) once knocked down, it is contemplated that the orifice plate 134 define therethrough a multitude of orifices 142. The multitude of orifices 142 are selected according to the size (i.e. size) of the protected space 12 such that an aggregation of the mass flows of the LRD fire suppressant agent 126 through each of the multitude of orifices 142 is sufficient for the application.

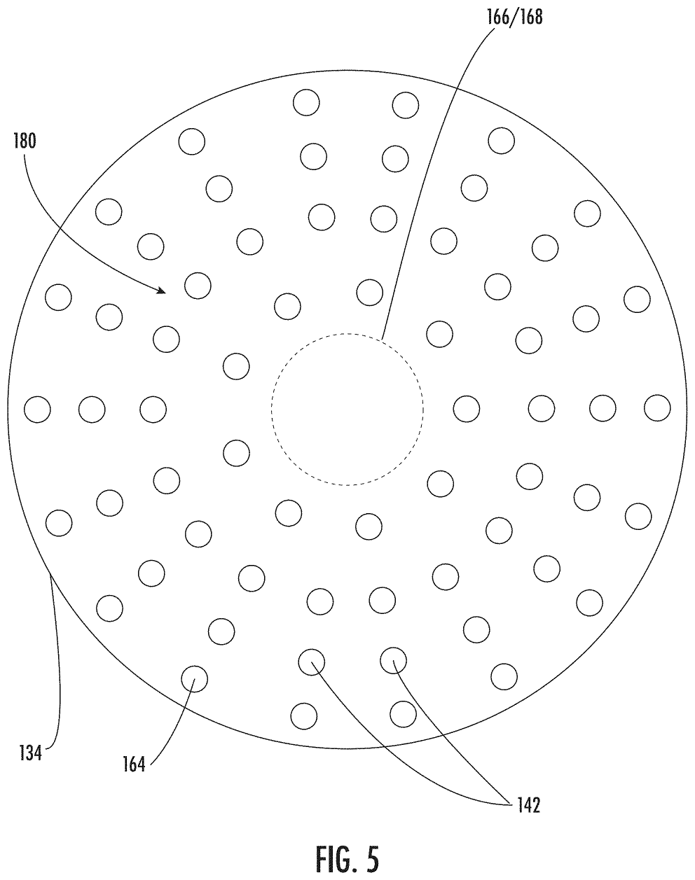

With reference to FIG. 5, the orifice plate 134 with a multitude 180 of orifices 142 is shown. It is contemplated that orifice flow areas 164 of each of the multitude 180 of orifices 142 be small. Specifically, each orifice flow area 164 is smaller than an inlet port flow area 166 of the inlet port 136 and an outlet port flow area 168. In certain examples an aggregate of the orifice flow areas 164 is smaller than either (or both) the inlet port flow area 166 and the outlet port flow area 168. In accordance with certain examples the aggregate of the orifice flow areas 164 can be less than either (or both) the inlet port flow area 166 and the outlet port flow are 168. It is contemplated that, in accordance with certain examples, the aggregate of the orifice flow areas 164 can be greater than either (or both) the inlet port flow area 166 and the outlet port flow area 168.

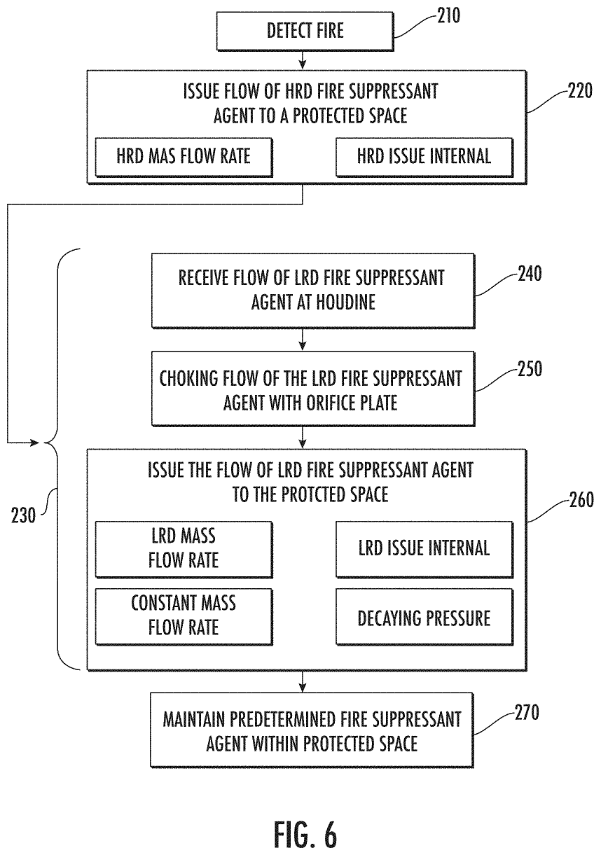

With reference to FIG. 6, a method 200 of controlling flow of a fire suppressant agent through a fire suppression system, e.g., the LRD fire suppressant agent 126 (shown in FIG. 2) through the fire suppression system 100 (shown in FIG. 1), is shown. The method 200 includes detecting fire in a protected space, e.g., the fire 14 (shown in FIG. 1) in the protected space 12 (shown in FIG. 1), as shown with box 210. The method 200 also includes issuing a flow of HRD fire suppressant into the protected space, e.g., the HRD fire suppressant agent 116 (shown in FIG. 2), as shown with box 220. The method 200 further includes issuing a flow of LRD fire suppressant, e.g., the LRD fire suppressant agent 126 (shown in FIG. 2), into the protected space, as shown with bracket 230. It is contemplated that issuing the flow of HRD fire suppressant flow include issuing the flow of HRD fire suppressant at an HRD mass flow rate for an HRD issue interval (as shown with box 222 and box 224), that the issuing the flow of LRD fire suppressant include issuing the LRD fire suppressant flow at an LRD mass flow rate for an LRD issue interval (as shown with box 232 and box 234), that the LRD mass flow rate be smaller than the HRD mass flow rate, and that the LRD issue interval be longer than the HRD issue interval.

As shown with box 240, issuing the flow of LRD fire suppressant agent include receiving a flow of LRD suppressant agent at a housing through an LRD source conduit, e.g., the LRD fire suppressant agent 126 (shown in FIG. 2) at the housing 132 (shown in FIG. 3) through the LRD source segment 128 (shown in FIG. 3). Issuing the flow of LRD fire suppressant also includes choking the flow of LRD fire suppressant agent through an orifice plate, e.g., the orifice plate 134 (shown in FIG. 3), as shown with box 250. The flow of LRD fire suppressant agent is thereafter issued to the protected space through an LRD supply segment, e.g., through the LRD supply segment 130 (shown in FIG. 3), as shown with box 260.

As shown with box 262, it is contemplated that the issuing the flow of LRD fire suppressant agent include issuing the flow of LRD fire suppressant agent to the protected space at a constant mass flow rate, e.g., the constant mass flow rate 162 (shown in FIG. 4). It is also contemplated that issuing the LRD flow include issuing the flow of LRD fire suppressant agent to the protected space at the constant mass flow rate while the pressure within a high-pressure plenum portion, e.g., the high-pressure plenum portion 152 (shown in FIG. 3), is above a predetermined value, e.g., the predetermined pressure value 170 (shown in FIG. 4), as shown with box 264. As shown with box 270, issuing the LRD fire suppressant flow in issuing the LRD fire suppressant flow at a mass flow rate sufficient to maintain a predetermined concentration level within the protected space during decay of pressure within an LRD pressure vessel connected to the LRD source segment, e.g., the LRD pressure vessel 118 (shown in FIG. 2), as shown with box 280.

Fire suppression systems, such as for cargo compartments on aircraft, commonly discharge fire suppressant agent into protected spaces in an HRD stage and an LRD stage. The HRD stage typically entails issuing suppressant at an HRD mass flow rate sufficient to knock down fire within the protected space. The LRD stage generally entails issuing additional suppressant into the protected space at a flow rate sufficient to maintain concentration of the fire suppressant agent within the protected space sufficient to prevent re-ignition of the fire. Such fire suppression systems generally control issue of fire suppressant into the protected space during this second stage using flow control devices, such as pressure regulators and/or flow control valves, to manage mass flow rate as pressure within the fire suppressant pressure vessel decays during the issue interval.

In LRD sections described herein orifice plates having a multitude of small diameter orifi are employed to utilizes the constant mass flow characteristics of an orifice choked flow condition. At such conditions related between fluid properties, orifice geometry, size, and upstream and downstream pressure where supersonic velocities are achieved, the flow through each of the multitude of small diameter orifi becomes choked and a maximum mass flow rate through each of the multitude of small diameter orifi is attained. Since conditions for choked flow of fire extinguishing agents through small diameter orifi generally do not discharge a sufficient quantity of agent to meet the concentration requirements, the multitude of orifi extend in parallel with one another to provide choked flows of fire suppressant agent throughout the discharge time that, in an aggregate, provide an aggregated mass flow rate sufficient to meet the concentration requirement for the protected space.

Advantageously, employment of an orifice plate having a multitude of orifices configured to provide choked flow limits system weight, cost, and/or complexity by eliminating the need for pressure regulating components and/or flow metering devices. Further, such orifice plates enable issuing the fire suppressant argent at a constant mass flow over time, avoiding (or eliminating entirely) the decaying mass flow rate with time generally provided with conventional fire suppression systems.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A low rate discharge (LRD) section of a fire protection system, comprising:
an LRD conduit with a source segment and a supply segment;
a housing connecting the source segment to the supply segment; and
an orifice plate arranged within the housing and fluidly coupling the source segment to the supply segment, wherein the orifice plate defines a plurality of orifices therethrough to choke flow of a fire suppressant traversing the orifice plate.

2. The LRD section of claim 1, wherein the housing has an inlet port with an inlet port flow area, wherein each of plurality of orifices has an orifice flow area, and wherein the orifice flow area is smaller than the inlet port flow area.

3. The LRD section of claim 2, wherein an aggregate of the orifice flow areas is smaller than the inlet port flow area.

4. The LRD section of claim 2, wherein an aggregate of the orifice flow areas is larger than the inlet port flow area.

5. The LRD section of claim 2, wherein an aggregate of the orifice flow areas is equivalent to the inlet port flow area.

6. The LRD section of claim 1, wherein the housing has an outlet port with an outlet port flow area, wherein each of plurality of orifices has an orifice flow area, and wherein the orifice flow area is smaller than the outlet port flow area.

7. The LRD section of claim 6, wherein an aggregate of the orifice flow area is (a) smaller than the outlet port flow area, (b) larger than the outlet port flow area, or (c) equivalent to the outlet port flow area.

8. The LRD section of claim 1, wherein a first orifice defines a first flow axis, wherein a second orifice defines a second flow axis, wherein the second flow axis is parallel to the first flow axis.

9. The LRD section of claim 1, further comprising an LRD pressure vessel fluidly coupled to the orifice plate by the source segment.

10. The LRD section of claim 9, further comprising a fire suppressant agent contained within the LRD pressure vessel.

11. The LRD section of claim 9, further comprising one or more of a chlorofluorocarbon, a hydrochlorofluorocarbon, and a hydrofluorocarbon compound contained within the LRD pressure vessel.

12. The LRD section of claim 1, further comprising an LRD element arranged along the source segment with an LRD active state and an LRD inactive state, the LRD element fluidly coupling an LRD pressure vessel to the orifice plate in the LRD active state, the LRD element fluidly separating the LRD pressure vessel to the orifice plate in the LRD inactive state.

13. The LRD section of claim 1, wherein the LRD section does not include a pressure regulating device; and wherein the LRD section does not include a flow control device.

14. The LRD section of claim 1, wherein the plurality of orifices are configured to choking flow of a fire suppressant agent traversing the orifice plate, and wherein the plurality of orifices are configured to provide a continuous, choked, fire suppressant flow having a mass flow rate sufficient to maintain a predetermined concentration level within a protected space during decay of pressure within an LRD pressure vessel connected to the source segment.

15. A fire suppression system, comprising:
a protected space;
an LRD section as recited in claim 1, wherein the supply segment fluidly couples the orifice plate to the protected space; and
a high rate discharge (HRD) section fluidly coupled to the protected space by an HRD conduit.

16. The fire suppression system of claim 15, further comprising:
an LRD pressure vessel connected to the protected space by the source segment of the LRD section;
one or more of a chlorofluorocarbon, a hydrochlorofluorocarbon, and a hydrofluorocarbon compound contained within the LRD pressure vessel;
an HRD pressure vessel connected to the protected space by the HRD conduit; and
one or more of a chlorofluorocarbon, a hydrochlorofluorocarbon, and a hydrofluorocarbon compound contained within the HRD pressure vessel.

17. The fire suppression system of claim 15, further comprising:
an LRD element arranged along the LRD source segment and separating an LRD pressure vessel from the protected space; and
an HRD element arranged along the HRD conduit and separating an HRD pressure vessel from the protected space.

18. The fire suppression system of claim 17, further comprising a sensor operatively connected to the LRD element and the HRD element, the sensor disposed in communication with the protected space, wherein the protected space is a cargo compartment on an aircraft.

19. A method of controlling flow of a fire suppressant agent through a fire suppression system, comprising:
at a low rate discharge (LRD) section including an LRD conduit having source segment and a supply segment, a housing connecting the source segment to the supply segment, and an orifice plate arranged within the housing and fluidly coupling the source segment to the supply segment, the orifice plate defining therethrough a plurality of orifices;
receiving a fire suppressant flow at the housing through the source segment;
choking flow of a fire suppressant traversing the orifice plate; and
issuing a continuous, choked, fire suppressant flow to a protected space through the supply segment.

20. The method of claim 19, wherein the fire suppressant flow has a mass flow rate sufficient to maintain a predetermined concentration level within the protected space during decay of pressure within an LRD pressure vessel connected to the source segment.
